(19) United States
(12) Patent Application Publication
(10) Pub. No.: US 2024/0336767 A1
(43) Pub. Date: Oct. 10, 2024

(54) FLAME RETARDANT NUCLEATING COMPOSITIONS AND CORRESPONDING FORMULATIONS FOR POLYSTYRENE FOAMS

(71) Applicants: ITALMATCH CHEMICALS SPA (50%), Arese (MI) (IT); ISOCHEMICALS SRL (50%), Malo (VI) (IT)

(72) Inventors: Ugo Zucchelli, Arese (MI) (IT); Vincenza Morone, Arese (MI) (IT); Antonio Peserico, Malo (VI) (IT)

(73) Assignees: ITALMATCH CHEMICALS SPA (50%), Arese (MI) (IT); ISOCHEMICALS SRL (50%), Malo (VI) (IT)

(21) Appl. No.: 18/293,612

(22) PCT Filed: Aug. 9, 2021
(86) PCT No.: PCT/IB2021/057332

§ 371 Date: Jan. 30, 2024

(51) Int. Cl. C08K 13/02; C08J 3/22; C08J 9/00; C08K 3/32; C08K 5/01; C08K 5/3492; C08K 5/523; C08L 25/06

(52) U.S. Cl. CPC C08K 13/02; C08J 3/226; C08J 9/0095; C08L 25/06; C08J 2325/06; C08J 2447/00; C08K 3/32; C08K 5/01; C08K 5/34922; C08K 5/523; C08K 2201/014; C08L 2201/02; C08L 2203/14; C08L 2310/00

(57) ABSTRACT

The invention relates to environmentally friendly flame retardant nucleating compositions, and corresponding formulations and processes useful for the production of polystyrene foams with low densities and a very low halogen content in the final product. The flame retardant composition according to the present invention achieves good flame retardancy and excellent recycling performances, with about the same loading of traditional halogenated compound, which does not affect the process and the physical and mechanical properties of the final foam and can be considered halogen free, according to some international standards.

### SUBJECT OF THE INVENTION

The invention relates to environmentally friendly flame retardant nucleating compositions, and corresponding formulations and processes useful for the production of polystyrene foams with low densities and a very low halogen content in the final product. The flame retardant composition according to the present invention achieves good flame retardancy and excellent recycling performances, with about the same loading of traditional halogenated compound, which does not affect the process and the physical and mechanical properties of the final foam and can be considered halogen free, according to some international standards.

### BACKGROUND OF THE INVENTION

It is well known that polystyrene foam polymers are particularly sensitive to the ignition with flame, and this is the reason why they need a suitable protection, in terms of flame retardant properties. According to the prior art, the flame retardant property is achieved by means of addition of at least an organic halogenated compound, particularly a brominated compound, with or without other conventional additives such as antiacids, dripping and radicals promoters, nucleators, colours, lubricants and thermal and processing stabilizers. Polystyrene foams must combine sufficient flame retardant properties with good physical properties. To achieve this target, flame retardants containing aliphatic bromine are mainly used in polystyrene foams because they are very efficient at relatively low loading, when compared to flame retardants containing aromatic halogen. This is very likely, because aliphatic bromine flame retardants under the heat of the flame release halogen in the gas phase at relatively low temperature reducing extinguishing time and they increase polymer degradation in the solid polymer phase as well. The accelerated polymer degradation under flame contributes to extinguish the flame due to a physical effect called “dripping effect”. However, on the other hand, the incorporation of aliphatic bromine compounds results often in poor skin quality and in a high degree of degradation of the styrene polymer in the extrusion process, due to excessive heating, resulting also in reduction of the molecular weight of the styrene polymer foam and of the recycled styrene polymer and bringing a drop in physical properties. For the above reasons, it is well known that at least a certain amount of halogenated compound, if not the total of it, could be reduced by so called “dripping and radical promoter” additives. “Antiacids” additives are also often used in combination with aliphatic bromine flame retardants, to reduce degradation during processing. Foam quality in term of homogeneity of cell dimensions and shape, is also an important factor for thermal insulation characteristic and mechanical strength. To improve foam quality, “nucleators” additives are often used. Nucleators are organic or inorganic, they can be used alone or in combination. Nucleators are a kind of inorganic filler and most commonly used nucleator is talc.

Halogens are, however, under public and regulatory pressure, due to their intrinsic characteristics, due to the possibility that their use could cause bioaccumulation in the environment and health hazard, as well as due to the strong pressure which exists to avoid the use of halogenated compounds in polymeric compositions.

In view of the above, intensive research is ongoing to find out suitable substitute compounds or compositions, which allow to avoid or greatly reduce the use of halogen derivatives in flame retarded polymeric compositions.

Generally speaking, the “new generation” of flame retardant compositions should fulfil some basic requirements, here below schematically indicated:
Flame Retardant (FR) additives should have an as lower as possible halogen content, due to environmental reasons;
FR additives total loading should be as lower as possible in order to not affect mechanical properties of the final composition;
FR additives should have suitable thermal resistance to be processed safely at temperatures of at least 180° C. or higher, for example temperatures up to 250° C.;
FR additives should have low toxicity.

Many solutions have been recently proposed for reducing halogen content in polystyrene foams.

For example, WO 2000/12593 describes a flame retarded polymer composition comprising a styrene polymer, a phosphorus compound and less than 2.5% of HBCD (Hexabromocyclododecane). Hexabromocyclododecane is, however, known to cause bioaccumulation. Environmentally friendly flame retardant and nucleating compositions according to the present invention are, in fact, preferably Hexabromocyclododecane free. In any case, the minimum content of bromine in WO 2000/12593 reported examples is equal to 0.5% (5000 ppm) by weight on the total percentage of the composition, which is, however, a still high amount of bromine, compared to the subject matter of the present invention.

US 2009/0149561 describes polymer foams prepared using 5,5-bis(bromomethyl)-2-oxo-1,3,2-dioxaphosphorinane or brominated 2-oxo-1,3,2-dioxaphosphorinane compounds. The minimum content of bromine in US 2009/0149561 reported examples is, however, equal to 0.8% (8000 ppm) by weight on the total percentage of the composition, which is, in any case, a still quite high amount.

WO 2010/083068 discloses a polystyrene foam composition containing at least 0.8% (8000 ppm) by weight, on the total percentage of the composition, of bromine and at least 1.5% by weight, on the total percentage of the composition, of graphite. Also these compositions, as disclosed in WO 2010/083068, contain a quite relevant amount of halogenated compound.

WO 2008/039833 discloses polystyrene foam compositions with very low colour, containing N, 2-3-dibromopropyl-4,5-dibromohexahydrophthalimide, a flame retardant agent (FR) that does not tend to degrade when processed. However, the preferred concentration of the FR agent is, according to WO 2008/039833, comprised between 3% and 4% by weight, on the total percentage of the composition, and more particularly 3.5% by weight, on the total percentage of the composition, thus corresponding to a bromine content of 2.2% by weight, on the total percentage of the composition.

WO 2012/168746 discloses extruded polystyrene foams with a very low halogen content and Hexabromocyclododecane free. WO 2012/168746 claim 12 states that the final halogen content is lower than 0.8% (8000 ppm) by weight and more preferably 0.6% (6000 ppm) by weight by weight, with respect to the total composition. In the examples according to WO 2012/168746, the lower halogen content reported for the foam is 0.31% (3100 ppm) by weight, while it is reported in the description of WO 2012/168746 that polymeric mixtures containing less than 0.1% (1000 ppm) by weight of halogen do not show satisfactory flame retardant properties.

In recent years, industry and international category associations are developing standards for the definition and quantification of halogen content in products. Different terms like low halogen, halogen free, non-halogenated and zero halogen are sometimes used to express similar halogen content.

For instance the term “Halogen-Free” does not necessarily indicate a complete absence of halogens but, instead, a content of Halogen below 3000 ppm (0.3%) by weight, 2000 ppm (0.2%) by weight, 1000 ppm (0.1%) by weight or 900 ppm (0.09%) by weight, as can be seen in the following examples.

According to JPCA-ES-01-1999 (by Japan Printed Circuit Association), IEC 61249 Feb. 21-2003 (by International Electrotechnical Commission), the criteria for defining “Halogen Free” in PBC laminates and materials is content of Bromine≤900 ppm; or content of Chlorine≤900 ppm and eventually 1500 ppm total halogens (Bromine and Chlorine).

According to DIN VDE 0472-815:1989 (by German Commission for Electrical Engineering, Electronic and IT)., IEC 60754-1:2011, and EN 50267 Feb. 1:1998 materials with content of Bromine or Chlorine≤2000 ppm and Fluorine≤1000 ppm are regarded as halogen-free. DIN VDE 0472-815:1989, originally designed for cables, wires and flexible cords is sometime used also for other applications.

According to NPG/PS 117:2014 (by the Nordic Pipe Group Association) a flame retardant halogen free conduit systems for cable management made of polypropylene, contains less than 1000 ppm of halogen.

According to EN 50642:2018 (by European Committee for Electrotechnical Standardization, CENELEC), a flame retardant halogen free conduit systems for cable management, made of polymeric material, contains:
Bromine≤1500 ppm;
or has a content of Chlorine≤1500 ppm,
or a content of Fluorine≤3000 ppm,
or a content of Iodine≤3000 ppm
or the total content of Bromine, Chlorine, Fluorine and Iodine is ≤4000 ppm.

However, differences exist in the terminology and requirements used as well as in the test methods for the detection of halogen content.

For instance, the European Standard EN 50642:2018 specifies a definition of halogen content and a method for its determination in polymeric or composite material. Halogen content is the amount of halogens contained as organic and inorganic compounds that can be converted to halide (fluoride, chloride, bromide, iodide) by combustion in a closed system containing oxygen (calorimetric bomb) and the subsequent analysis of aqueous solution in which the halide are absorbed and/or dissolved.

At the time of filing of the present application, new emerging standards are being written to define limits and detection methods for Halogen Free composition in different applications.

### OBJECT OF THE INVENTION

Object of the present invention is to provide flame retarded polystyrene foam compositions and articles, of low and medium densities, with good mechanical properties and good thermal insulating properties, said compositions and articles being characterized by a very low content of halogen, i.e. lower than 3000 ppm by weight and, preferably, lower than 1500 ppm by weight and, more preferably, lower than 900 ppm by weight. Such compositions are moreover free from hexabromocyclododecane.

Another object of the present invention is to provide flame retarded and nucleating thermoplastic concentrates (or masterbatches) to be used in the preparation of flame retarded foamed articles. Such flame retarded and nucleating concentrates for polystyrene foam maybe based on polystyrene or polyolefin carrier.

Still another object of the present invention is to provide a dry blend flame retardant and nucleating powder mixture to be used in the preparation of flame retarded polystyrene foamed articles.

Still another object of the present invention is to provide a flame retarded and nucleating composition easy to process and suitable for recycling within the extrusion process itself or using material of post-consumer origin.

### DESCRIPTION OF THE INVENTION

The above objects, according to present invention, are achieved by a composition comprising the following components:
a) at least a polystyrene polymer
b) at least a phosphorus compound with oxidation state lower than +5, not meltable or not softening in the mould of polystyrene during processing, or mixtures
c) at least an halogenated compound meltable or not meltable or softening in the mould of polystyrene during processing, or mixtures
d) at least a dripping and radical promoter, or mixtures
e) at least a phosphorus compound with oxidation state +5 or lower, in the liquid form or meltable or softening in the mould of polystyrene during processing, or mixtures
f) Optionally other conventional additives like: antiacids, colours, lubricants, impact modifiers, thermal and processing stabilizers or carrier materials.
in which:
the total percentage by weight of components a) to f) must be 100%
the sum of components from b) to e) in the polystyrene foam composition is lower than 10% by weight, preferably lower than 5% by weight and more preferably lower than 2.5% by weight.
the sum of components b) and c) in the final polystyrene composition is lower than 4% by weight, preferably lower than 2% by weight and more preferably lower than 1% by weight.
the weight percent of the halogenated compound c) depends on the chemical nature of the compound used, however the pure halogen content must be lower than 3000 ppm by weight and preferably lower than 1500 ppm by weight and more preferably lower than 900 ppm by weight on the total percentage of the flame retarded polystyrene foam composition.

### DETAILED DESCRIPTION OF THE INVENTION

Polystyrene foams products are produced with two different methods: by direct extrusion into boards or by sintering of beads into a shaped mould. Commonly these products are referred to as “XPS” (Extruded Polystyrene) and “EPS” (Expanded Polystyrene) respectively. In the expanded method (EPS) small polystyrene beads may be created directly from styrene monomer polymerization in a solvent suspension and permeated with a blowing agent as for instance pentane, and successively expanded in a shaped mould with steam vapour. Alternative, pre-expanded or expandable beads can be created from polystyrene pellets directly in extrusion from already polymerized polystyrene pellets.

In the extrusion methods (XPS) instead, the polymer is converted by heat and pressure into a homogeneous melt and forced through a die into boards. To obtain a cellular structure, the plastic incorporates blowing agents directly injected during extrusion at high pressure to form an homogeneous composition into the melt.

These blowing agents must have a boiling point lower with respect to the boiling point of the expandable polystyrene and may be flammable or not flammable. They can be used alone or in combinations.

Examples of useful blowing agents are carbon dioxide, water, nitrogen or aliphatic hydrocarbons having 3 to 5 carbons, alcohols, ketones and ethers.

These expanding agents are very often used in mixtures and are typically employed in amounts comprised in the range between 1 to 30% by weight with respect to the total weight of the expandable material. During the foaming process, blowing agents are dispersed as uniform as possible, then leaved to expand at reduced or atmospheric pressure.

Various factors influence the porosity and the cellular structure resulting from the foaming process.

Temperature and throughput rate during extrusion as well as material parameters such as viscosity strongly affect the foaming behaviour. To achieve a maximum density reduction of the foam and a fine homogeneous cellular structure, the processing conditions as well as the material parameters of the polymer (mainly molecular weight) have to be optimized. The nucleation of cells is strongly influenced by the magnitude and rate of the pressure drop at the end of the die. There are two major types of nucleation: homogeneous nucleation and heterogeneous nucleation. Homogeneous nucleation occurs at the bulk phase of the polymer matrix. On the other hand, heterogeneous nucleation occurs at the interface between a solid phase and the polymer. According to the classical nucleation theory, heterogeneous nucleation requires less energy to take place and result in higher cell density as well as smaller and uniform cell size distribution. Talc is widely used as a nucleating agent to give better quality to foams, due to high cell density and small cell size. Several kind of talc with different purity exist, however, most talc influence negatively the flame retardancy of phosphorus based products. Moreover, the total amount of additives has to be kept to the minimum to maintain mechanical and physical properties of the foam.

The density range of polystyrene foam is about 10-45 kg/m³. Present invention is particularly aimed to foam with low density, i.e. lower than about 45 kg/m³ or preferably lower than 40 kg/m³ or more preferably lower than 35 kg/m³.

According to the present invention, the not meltable additives play a double role of flame retardant and nucleating agent in the foam.

Similarly, the meltable or liquid phosphorous additive acts as a flame-retardant agent and as plasticizer that improves fire performance and foamability of the foam by modifying polystyrene rheology and dispersion of the not meltable additive as well.

### a) Styrene Polymers

Polystyrene formed from styrene monomer or copolymer can be used. Co-monomer content is preferably less than 20% while viscosity can be in a wide range, for instance polymers with melt flow rate (MFR) in the range of 0.5 to 30 gr/10′. Recycled polymer can be mixed to styrene polymer melt in the amount from 1% up to 100%.

b) Phosphorus Compound with Oxidation State Lower than 5, not Meltable or not Softening in the Mould of Polystyrene During Processing

Phosphorus compounds with oxidation state lower than +5 that are not meltable or softening in the mould of polystyrene have the double scope of flame retardant and heterogeneous nucleator to increase density of foam with a specific expansion gas system.

Many excellent known flame retardant agents are represented by organic or inorganic phosphorus-containing compounds, in which the phosphorus atom has an oxidation state ranging from −3 to +5. A definition of the term “oxidation state” has been, for example, published by Karen, P.; McArdle, P., Takats, J. (2016). “Comprehensive definition of oxidation state (IUPAC Recommendations 2016)”. Pure Appl. Chem. 88. Phosphorus lower oxidation state compounds (−3, −1, 0, +1, +3) are generally more efficient as flame retardant agents than phosphorus higher oxidation state compounds, because the release of phosphorus-containing volatiles during burning, which contribute to the extinction of the flame, decreases with increasing of phosphorus oxidation state.

Present invention considers a flame retardant and nucleating ingredient phosphorus compound with oxidation state lower than +5, not meltable or not softening in the mould of polystyrene during processing. Polystyrene is usually processed at temperatures in the range 190° C. till 240° C., so not meltable or not softening according the present invention means that the phosphorus compound has a melting temperature measured by DCS or a softening point higher than 190° C., preferably higher than 220° C. and more preferably higher than 240° C.

Particularly preferred are phosphorous compounds with oxidation state lower than +5 with high flame retardant effectiveness in the polystyrene foam matrix. These preferred compounds, in addition to being not meltable or not softening in the mould of polystyrene during processing, must also have a degradation temperature compatible with that of polystyrene polymer. Polystyrene decomposes in the range 300° C.-430° C. when heated in nitrogen, and in the range 270° C.-400° C. when heated in air. Effectiveness of flame retardant compounds is high when decomposition occurs within the same temperature range.

Particularly preferred Phosphorous compounds with oxidation state lower than +5 not meltable or not softening in the mould of polystyrene during processing are characterized by a decomposition temperature range higher than 240° C. and lower than 400° C. when heated in air atmosphere as in combustion condition. Phosphorous compounds for the purpose of the present invention are inorganic phosphorous containing compounds and their salts or organic phosphorous containing compound and their salts.

Example of inorganic phosphorous compound are: Red Phosphorus (RP) and metal phosphinate. Aluminium hypophosphite (AHP) and Calcium hypophosphite (CHP) are inorganic metal salts particularly suitable within the meaning of the present invention.

An example of organic phosphorous compound according the present invention is Pentaerythritol spiro dimethyl phosphonate (PSDP). It melts at a temperature of about 245° C., so it is within the meaning of the present invention.

Examples of organic-phosphorous salts with oxidation state lower than +5 according to present invention are Ammonium salt of 10-hydroxy-9, 10-dihydri-9-oxa-10-phosphaphenantrene-10-oxide (DXA12) and Melamine salt of 10-hydroxy-9, 10-dihydri-9-oxa-10-phosphaphenantrene-10-oxid. Other examples are metal salts of organic phosphorous compounds as Aluminium hydroxymethyl phenyl phosphinate and Aluminium methyl methyl phosphonate (AMMP).

Aluminum diethyl phoshinate and Zinc diethyl phosphinate are organic phosphorus salts in oxidation state lower than +5, not meltable or softening in the mould of polystyrene process, however they shown decomposition temperature higher than polystyrene polymer in pyrolysis and in oxidation conditions. Their relatively high decomposition temperature delays the release of phosphorus-containing volatiles during burning, which in turn contribute to the extinction of the flame. Indeed, Aluminum diethyl phoshinate and Zinc diethyl phosphinate have been shown not to be sufficiently efficient as flame retardants and therefore they are not in the framework of present invention.

### c) Halogen Containing Flame Retardant

In the meaning of the present invention, the halogenated compound can be any organic or inorganic product, meltable, not meltable or sublimating, with low molecular weight or polymeric, containing one or more bromine or chlorine atoms in a percentage ranging from about 10% to about 80% by weight with respect to the total weight of the compound. Bromine containing flame retardant compounds with a sufficiently high decomposition temperature, for example higher than 190° C., are mostly preferred.

Melamine hydrobromide (1,3,5-triazine-2,4,6-triamine, hydrobromide) CAS 29305 December 2 is an example of an halogen organic salt that may be used as halogen containing flame retardant agent within the meaning of the present invention.

Of the various brominated organic compounds, typically aliphatic brominated containing compounds are utilized in polystyrene foams.

Brominated butadiene copolymers, CAS No. 1195978-93-8 is an example of aliphatic halogen containing polymeric flame retardant agent, and they are particularly within the meaning of the present invention.

Tetrabromobisphenol A bis(2,3-dibromo-2-Methylpropyl ether), CAS 97416-84-7, is an example of an halogen flame retardant agent which contains in the same molecule both an aromatic and aliphatic moiety, and it is also particularly within the meaning of the present invention.

Tetrabromo bis phenol A bis(2,3-dibromopropyl ether) CAS 21850-44-2 is another example of an halogen containing flame retardant agent which contains in the same molecule both an aromatic and aliphatic moiety, and it is also within the meaning of the present invention.

Chloroparaffine CAS 63449-39-8 is an additional example of chlorine containing flame retardant agent, also within the scope of the present invention.

Tris (tribromoneopentyl) phosphate CAS 19186-97-1 is a further example of an halogen containing flame retardant agent containing an aliphatic moiety and a phosphoric acid ester link, and it is also within the meaning of the present invention.

Tris-(2,4,6-tribromophenoxyl)-1,3,5-triazine CAS 25713-60-4 is another example of an halogen containing flame retardant agent containing an aromatic moiety and a nitrogenated ring, and it is also within the meaning of the present invention.

Tris-(2,3-dibromopropyl) isocyanurate CAS 52434-90-9 is an example of an halogen containing flame retardant agent containing an aliphatic moiety and a nitrogenated ring, and it is also within the meaning of present invention.

The halogenated compounds according to the present invention may be also used in a multiple combination, i.e. as mixtures.

d) Dripping and radical promoter
Selected Radical Precursors May Also Play a Significant Role as Flame Retardant Agents for Various polymers. From the viewpoint of flame retardancy of polymers mainly radical generators triggered by thermolysis or redox systems have been successfully used to suppress and retard the fire response of polymeric materials. Certain peroxides can be used as synergic agents to enhance the action of brominated flame retardants, whereas azo compounds, disulfides and alkoxyamines have been shown to provide self-extinguishing properties to polymers even by themselves. It is believed that these additives interrupt or delay the combustion process that takes place in the gas phase by terminating the highly reactive radicals OH· and O· produced from the chain-branching reaction of combustion. Novel thermoplastic moulding compositions according to the present invention also contain organic compounds which forms free radicals during flaming. Said organic compounds, which enable a further reduction of the flame retardant of the composition, can be for example selected among one or more of the following products: 2,3-dimethyl 2,3-diphenyl butane, 2,3-dimethyl 2,3-diphenylhexane, poly (1,4-diisopropyl benzene), dicumyl peroxide or di-tert-butyl peroxide. These products are generally used in an amount of between 0.01% to 1% by weight on the weight of total polystyrene compound, preferably between 0.05% and 0.5% by weight with respect to the total weight of the composition.
e) Phosphorus Compound with Oxidation State +5 or Lower, in the Liquid Form or Meltable or Softening in the Mould of Polystyrene During Processing

Phosphorus compounds with oxidation state +5 or lower that are meltable or softening in the mould of polystyrene have the double scope of flame retardant and to decrease heterogeneous nucleation effect and so density of foam with a specific expansion gas system. Without being link to any theory, it is believed that the decrease in foam density is due to a double effect of decreasing the polystyrene foaming temperature, viscosity and decrease of the heterogenous nucleation effect. Indeed a foam with lower density is formed when the foaming temperature is lowered to account for the lowering of the glass transition temperature of the styrene polymer due to the higher solubility of the meltable phosphorus compound in the styrene polymer, or due to a decrease of melt viscosity as well. Also, because the heterogeneous nucleation effect is affected from the interface solid particle vs polymer and interfacial tension, the meltable phosphorus compound reduces the effectiveness of the solid nucleation sites. Whatever the explanation, the meltable phosphorus has been found to reduce or delay the nucleation effect and reduce the foam density and improve flammability behaviour as well.

Present invention considers a flame retardant phosphorus compound with oxidation state +5 or lower, meltable or softening in the mould of polystyrene during processing. Polystyrene is usually processed at temperatures in the range 190° C. till 240° C., so meltable or softening in the mould of polystyrene during processing, means that the phosphorus compound has a melting temperature measured by DCS or a softening point lower than 240° C., preferably lower than 220° C. and more preferably lower than 190° C. Liquid phosphorus compounds with oxidation state +5 or lower are also preferred.

Phosphorous compounds with oxidation state +5 may be any organic compound which contains one or more phosphorous atoms and includes, but is not limited to, phosphates of the formula (RO)₃PO wherein each R is independently selected from a substituted or unsubstituted, saturated or unsaturated, branched or straight-chain aliphatic moiety or a substituted or unsubstituted aromatic moiety. Suitable phosphates include, but are not limited to, triphenylphosphate (TPP), tributylphosphate, triethylphosphate, trimethylphosphate, tripropylphosphate, trioctylphosphate, diphenyl cresylphosphate, diphenyl methylphosphate, tris-(2-ethylhexyl) phosphate, isodecyl diphenylphosphate, isooctyl diphenylphosphate, bisphenyl diphenylphosphate, trixylil phosphate, and triisopropylphenylphosphate. Among phosphate compounds, resorcinol bis (2,6-dixylenyl phosphate) having a melting point at about 100° C. is particularly suitable within the meaning of the present invention. Other phosphorous compounds suitable for use in the present invention are phosphites of the formula (RO)₃P, phosphonates of the formula (RO)₂RPO, phosphinates of the formula (RO)R₂PO, phosphine oxides of the formula R₃PO, phosphines of the formula R₃P, and phosphonium salts of the formula R₄PX, wherein each R is independently selected from substituted or unsubstituted, saturated or unsaturated, branched or straight-chain aliphatic moieties or substituted or unsubstituted aromatic moieties and X is a suitable counter ion. Of the above described phosphorous compounds with oxidation state lower than +5 are preferred phosphinate as 9,10-Dihydro-9-oxa-10-phosphaphenanthrene 10-oxide, that melt at about 120° C.

### f) Optional Components

Optional components are conventional additives like for example: antiacids, colours, lubricants, impact modifiers, thermal and processing stabilizers, or carriers.

Normally components b) to f) are premixed with thermoplastic resin (carrier) and extruded into pellets in order to prepare one or more masterbatches (or concentrates) which contain single components or whole components dispersed in a predetermined ratio.

The chosen component of the masterbatch polymer carrier is polystyrene, but also other polymers can be used as carriers, provided that they would be melt blendable with polystyrene itself. Polymer carriers like polyolefins, for instance, may be advantageous. Particularly effective is, for example, low density polyethylene with high fluidity and low melting point, that can improve dispersion of additives during processing as well as mechanical properties of the final foam.

### EXAMPLES

Materials used:
a) Polystyrene: general purpose crystal polystyrene with MFR 230° C., 2.16 kg=10 gr/10′, herein briefly called “PS”
b) Phosphorus compound with oxidation state lower than 5, not meltable or not softening in the mould of polystyrene during processing and with a decomposition temperature range higher than 240° C. and lower than 400° C. when heated in air

Aluminium methyl methyl phosphonate, here briefly “AMMP”.

Aluminium hypophosphite (Phoslite® IP-A), manufactured by Italmatch Chemicals Spa, here briefly “AHP.

Red Phosphorus (SafestR B2XF), manufactured by Italmatch Chemicals Spa, here briefly “RP”.

Ammonium salt of 10-hydroxy-9, 10-dihydri-9-oxa-10-phosphaphenantrene-10-oxide, here briefly “DXA12”.
c) Halogen containing flame retardant

Brominated butadiene copolymers (CAS No. 1195978-93-8), here briefly “FR122P”, Bromine content around 63%, melting range 120° C.-140° C.

Tetrabromobisphenol A Bis (2,3-dibromo-2-methylpropylether), CAS 97416-84-7, here briefly “AP1300SF”, Bromine content around 65%, melting range around 100° C.-110° C.

Melamine hydrobromide (MelagardR MHB) manufactured by Italmatch Chemicals Spa; here briefly “MHB”, Bromine content around 38%, not meltable but decompose/sublimate at around 200° C.
d) Dripping and radical promoter 2,3-dimethyl 2,3-diphenylbutane (CAS 1889-67-4), here briefly “DIC”, melting range 90° C.-110° C.
e) Phosphorus compound with oxidation state +5 or lower, in the liquid form or meltable or softening in the mould of polystyrene during processing

Resorcinol bis (2.6-dixylenyl phosphate) (CAS 139189-30-3), here briefly “PX-200”.

9,10-Dihydro-9-oxa-10-phosphaphenanthrene 10-oxide (CAS 35948-25-5), here briefly “DOPO”
F) Other additives

Hydrotalcite is a naturally occurring mineral having the formula 6 MgO·Al₂O₃CO₂·12 H₂O or Mg₆Al₂(OH)₁₆CO₃·4H₂O and used among other as an antiacid with Halogen containing flame retardant to reduce degradation and colour during processing. Synthetic hydrotalcite can be produced with several known method, here briefly “SHT”.

### Equipment and Tests:

Polystyrene boards low density production description (table 1):

Polystyrene pellets and additives masterbatches compositions as in table 1 are feed into main hopper of a 40 mm single screw extruder at around 80 kg/hour. The melt from this first extruder goes into a melt pump feeding a second extruder of 90 mm equipped with a flat die of 150 mm width. Boards 40 mm thick are produced. At half of the barrel of the first extruder a mixture CO₂-Ethanol at dosing rates respectively of 2.25% by weight and 3.25% by weight and 100 bar pressure. Melt temperatures are keep at 200° C. in first extruder, then feed at 150° C. from the melt pump to second extruder and keep at 150° C. for the first half of second extruder. In second half of second extruder, melt temperatures is lower at around 120° C. The melt temperatures at the die are measured and reported in table 1 as “Foaming temperature”.
Polystyrene boards very low density production description (table 2):

In the same extruder a mixture CO₂-Ethanol is added at dosing rates respectively of 3.25% by weight and 4.25% by weight and 120 bar pressure. Lower densities are achieved and reported in table 2.
Characterization of polystyrene foam sample boards (table 1 and 2):

Foam densities are measured according ASTM D 1622.

Fire behaviour is tested according EN 11925-2 in the condition of edge exposure and 15 sec ignition time. Six specimens, three obtained in the direction of extrusion board and three in the perpendicular direction, are tested for each sample. The extinguishing time and the flaming spread of the six specimens were recorded and the average values for every example reported in table 1 and table 2.

Fire performance of polystyrene foam is also measured with Limited Oxygen Index (LOI) according to ASTM D2863.
Thermal stability in Brabender, measurements description (table 3):

Around 60 grams of compositions as in table 2 are introduced into a Brabender torque rheometer at 190° C. for 15 minutes and then compression moulded into 1 mm thick plaques. Yellow index is measured with a spectrophotometer according to ASTM E313.

Limited Oxygen Index (LOI) is measured on moulded specimens according to ASTM D2863.

TABLE 1
Polystyrene boards low density compositions and tests results

| | C1 | C2 | C3 | C4 | C5 | C6 | C7 | C8 |
|---|---|---|---|---|---|---|---|---|
| PS (1) | 97% | 98.22% | 97.94% | 97.66% | 97.38% | 94% | 91.22% | 94.72% |
| Microcristalline | 0.5% | | | | | | | |
| talc * | | | | | | | | |
| PS (2) | 1.5% | 0.89% | 1.03% | 1.17% | 1.31% | 3% | 4.39% | 2.64% |
| FR122P * | 1% | 0.14% | 0.28% | 0.42% | 0.56% | | 0.14% | 0.14% |
| MHB * | | | | | | | | |
| AP1300SF * | | | | | | | | |
| AMMP * | | | | | | | | |
| AHP * | | 0.5% | 0.50% | 0.50% | 0.50% | 0.75% | 4% | 0.5% |
| RP * | | | | | | | | |
| DXA12 * | | | | | | | | |
| DIC * | | 0.25% | 0.25% | 0.25% | 0.25% | 0.25% | 0.25% | |
| PX-200 * | | | | | | 2% | | 2% |
| DOPO * | | | | | | | | |
| Bromine** | 0.63% | 0.09% | 0.18% | 0.27% | 0.36% | 0% | 0.09% | 0.09% |
| Foaming | 120 | 120 | 120 | 120 | 120 | 117 | 120 | 117 |
| temperature | | | | | | | | |
| (° C.) | | | | | | | | |
| Density | 39 | 40 | 40 | 40 | 40 | 41 | 40 | 40 |
| (kg/m3) | | | | | | | | |
| Extinguishing | 11 | 13 | 12 | 12 | 12 | 29 | 10 | 31 |
| time (sec) | | | | | | | | |
| Flame spread | 9 | 10 | 10 | 10 | 10 | >15 | 9 | >15 |
| (cm) | | | | | | | | |
| LOI | 26.5 | 23.5 | 23.6 | 23.5 | 23.4 | 22.5 | 23.6 | 22.0 |

| | C9 | E1 | E2 | E3 | E4 | E5 | E6 |
|---|---|---|---|---|---|---|---|
| PS (1) | 93.22% | 94% | 95.72% | 95.72% | 96.3% | 94.02% | 95.1% |
| Microcristalline | | | | | | | |
| talc * | | | | | | | |
| PS (2) | 3.39% | 3% | 2.14% | 2.14% | 1.85% | 2.99% | 2.45% |
| FR122P * | 0.14% | | 0.14% | 0.14% | | 0.14% | |
| MHB * | | 0.25% | | | 0.30% | | |
| AP1300SF * | | | | | | | 0.2% |
| AMMP * | | | | 0.75% | | | |
| AHP * | | 0.5% | 0.75% | | | | 0.5% |
| RP * | | | | | 0.4% | | |
| DXA12 * | | | | | | 1.5% | |
| DIC * | 0.25% | 0.25% | 0.25% | 0.25% | 0.15% | 0.35% | 0.25% |
| PX-200 * | 3% | 2% | | 1% | 1% | | 1.5% |
| DOPO * | | | 1% | | | 1% | |
| Bromine** | 0.09% | 0.09% | 0.09% | 0.09% | 0.114% | 0.09% | 0.13% |
| Foaming | 116 | 117 | 118 | 120 | 120 | 120 | 120 |
| temperature | | | | | | | |
| (° C.) | | | | | | | |
| Density | 42 | 40 | 39 | 41 | 42 | 41 | 40 |
| (kg/m3) | | | | | | | |
| Extinguishing | 33 | 8 | 10 | 12 | 9 | 15 | 12 |
| time (sec) | | | | | | | |
| Flame spread | >15 | 9 | 9 | 10 | 9 | 10 | 10 |
| (cm) | | | | | | | |
| LOI | 22.3 | 26 | 25.4 | 25.7 | 25.3 | 25.8 | 25.6 |

* added as Masterbatch 50% on PS (2) carrier
**bromine content in the compounds is calculated by halogen content (% by weight) of halogenated compounds used in the foam sample board composition (% by weight)

### Comments to Examples and Comparative Example in Table 1

According EN 11925-2 standard, Flame spread <150 mm within 20 sec after a flame ignition time of 15 sec indicates a good flame retardant performance, Flame spread >150 mm within 20 sec after a flame ignition time of 15 sec indicates a worse flame retardant performance. Similarly, low extinguishing times indicates a good flame retardant performance, high extinguishing times indicate worse flame retardant performance. Materials with a LOI greater than the atmospheric oxygen concentration (21%) are considered fire retardant performing. Higher the LOI value, higher the flammability performance.

### Comparative Example C1 Represent Previous Art

Example E1 of present invention is showing a good flame retardant performance similar to example C1 of previous art.

Comparative examples from C2 to C5 show that increasing halogen content in presence of not meltable phosphorus compound in oxidation state lower than +5 and radical initiator does not increase the flame retardant performance.

Comparison of C6 with E1 shows that the presence of at least a small quantity of halogen is necessary for a good flame retardant performance of the composition of present invention. Surprisingly, a small quantity of halogen is sufficient to boost dramatically the flame retardant performance.

Comparison of C7 with C8 shows that the presence of radical initiator or dripping agent is necessary for a good flame retardant performance of present invention.

Comparison of C7 and C9 with E1 shows that the presence of both phosphorous compounds-is necessary for a good flame retardant performance of present invention, because increasing LOI value sensibly.

Examples from E2 to E6 show different compositions according to present invention containing different kind of halogen source, different kind of not meltable phosphorus in oxidation state lower than +5, different kind of meltable phosphorus in oxidation state +5 or lower and radical initiator or dripping agent.

TABLE 2
Polystyrene boards very low density compositions and tests results

| | C10 | E7 |
|---|---|---|
| PS (1) | 98.22% | 96.22% |
| PS (2) | 0.89% | 1.89% |
| FR122P * | 0.14% | 0.14% |
| AHP * | 0.5% | 0.50% |
| DIC * | 0.25% | 0.25% |
| PX-200 * | | 1% |
| Bromine | 0.09% | 0.09% |
| Foaming temperature (° C.) | 120 | 119 |
| Density (kg/m3) | 34 | 33 |
| Extinguishing time (sec) | 35 | 11 |
| Flame spread (cm) | >15 | 9 |

* added as Masterbatch 50% on PS (2) carrier

### Comments to Examples and Comparative Example in Table 2

Comparison of C10 with E7 shows that the composition of present invention is showing a good flame retardant performance on very low density polystyrene foam.

TABLE 3
thermal stability in Brabender - compositions and tests results

| | C11 | C12 | C13 | C14 | E8 |
|---|---|---|---|---|---|
| PS | 99.5% | 98.5% | 97.9% | 98.35% | 98.11% |
| Microcristalline talc | 0.5% | 0.5% | 0.5% | 0.5% | |
| FP122P | | 1% | 1% | 0.6% | 0.14% |
| SHT | | | 0.6% | 0.3% | |
| AHP | | | | | 0.5% |
| DIC | | | | 0.25% | 0.25% |
| PX-200 | | | | | 1% |
| YI | 0.5 | 11 | 7 | 3 | 1 |
| LOI | 18 | 25.3 | 23.0 | 24.0 | 23.6 |

### Comments to Examples and Comparative Example in Table 3

Yellowness Index (YI) is a number calculated from spectrophotometric data that describes the change in colour of the test sample from clear or white to yellow. High number indicates high degradation of the additives and polymer, low numbers indicate low degradation of the additives and polymer matrix.

Limited Oxygen Index (LOI) is measured on 3 mm thick compression moulded plaques according to ASTM D2863-97.

Comparison of C11 with C12 shows that brominated flame retardant at high loading increase flame retardant resistance while increasing degradation.

Comparison of C12 with C13 shows that antiacid reduce degradation while decreasing flame retardant performances.

Comparison of C14 with E8 shows that the claimed combination decrease degradation better than previous art technology, and so indicate a better performance in recycled melts.

1. Flame retarded and nucleating polystyrene foam composition comprising at least the following components:
a) A polystyrene polymer;
b) A phosphorus compound with oxidation state lower than +5, not meltable or not softening in the mould of polystyrene during processing, or mixtures thereof;
c) An halogenated compound, or mixtures thereof;
d) A dripping and radical promoter, or mixtures thereof;
e) A phosphorus compound with oxidation state +5 or lower, in the liquid form or meltable or softening in the mould of polystyrene during processing, or mixtures thereof;
f) Optionally conventional additives selected form antiacids, colours, lubricants, impact modifiers, thermal and processing stabilizers or carrier materials
wherein:
the total percentage of components a) to f) is 100%;
the Halogen content in the polystyrene foam composition is lower than 3000 ppm by weight
and
the sum of components b) to e) in the polystyrene foam composition is lower than 10% by weight.

2. Flame retarded and nucleating polystyrene foam composition according to claim 1, wherein said phosphorus compound b) is aluminium or calcium hypophosphite.

3. Flame retarded and nucleating polystyrene foam composition according to claim 1, wherein said halogenated compound c) is aliphatic bromine in polymeric or monomeric form or mixtures thereof.

4. Flame retarded and nucleating polystyrene foam composition according to claim 1, wherein said halogenated compound c) is melamine hydrobromide.

5. Flame retarded and nucleating polystyrene foam composition according to claim 1, wherein said dripping and radical promoter d) is 2,3-dimethyl 2,3-diphenylbutane.

6. Flame retarded and nucleating polystyrene foam composition according to claim 1, wherein said phosphorus compound e) is Resorcinol bis (2,6-dixylenyl phosphate).

7. Flame retarded and nucleating polystyrene foam composition according to claim 1 comprising:
a) Polystyrene polymer;
b) aluminum or calcium hypophosphite;
c) halogenated compound containing aliphatic bromine in polymeric or monomeric form or melamine hydrobromide or mixtures thereof;
d) 2,3-dimethyl 2,3-diphenylbutane;
e) Resorcinol bis (2,6-dixylenyl phosphate);
f) Optionally conventional additives selected from: antiacids, colours, lubricants, impact modifiers, thermal and processing stabilizers, or carrier materials,
wherein:
the total percentage of components a) to f) is 100%;
the Halogen content in the polystyrene foam composition is lower than 3000 ppm by weight;
and
the sum of components b) to e) in the polystyrene foam composition is lower than 10% by weight.

8. Flame retarded and nucleating concentrates or masterbatches for polystyrene foam compositions according to claim 1 or 7, comprising the following components:
a) polystyrene or polyolefin carrier resin from 70% to 30% by weight on the total weight of the composition,
wherein
the sum of said components b) to e) and optionally said component f) is from 30% to 70% by weight on the total weight of the composition;
said flame retarded and nucleating concentrates or masterbatches is used at a concentration “W %” by weight, that is lower than (0.3/X)*100 of the total weight of the foamed polystyrene composition so that the Halogen content in the final polystyrene composition is lower than 3000 ppm by weight respectively
and wherein:
“X” is the Halogen concentration in % by weight with respect to the total weight of said concentrate or masterbatch composition, depending by the specific selected halogenated compound c).

9. A flame retardant and nucleating powder mixture for polystyrene foam composition according claim 1,
wherein:
the sum of components b) to e) and optionally said component f) is 100%;
said flame retardant and nucleating powder mixture is used at concentration “Z %” by weight that is lower than (0.3/Y)*100 of the total weight of the foamed polystyrene composition so that the content of Halogen in the final polystyrene composition is lower than 3000 ppm by weight respectively
and wherein:
“Y” is the Halogen concentration in % by weight respect to the total weight of said powder mixture composition, depending by the specific halogenated compound c).

10. Flame retarded and nucleating polystyrene foam composition according to claim 1, wherein the density of said polystyrene foam is lower than about 45 kg/m³.

11. Flame retarded and nucleating polystyrene foam composition according to claim 1, further comprising from 1% to 100% by weight of component a) wherein said component a) is recycled material.

12. Method of preparing polystyrene foam composition characterized by low density and a very low halogen content with the Use of flame retardant components and formulations according to claim 8, said method comprising
feeding polystyrene pellets and additive s into main hopper of a single screw extruder.

13. The flame retarded and nucleating polystyrene foam composition according to claim 1, wherein the Halogen content in the polystyrene foam composition is lower than 1500 ppm by weight.

14. The flame retarded and nucleating polystyrene foam composition according to claim 1, wherein the Halogen content in the polystyrene foam composition is lower than 900 ppm by weight.

15. The flame retarded and nucleating polystyrene foam composition according to claim 1, wherein the sum of components b) to e) in the polystyrene foam composition is lower than 5% by weight.

16. The flame retarded and nucleating polystyrene foam composition according to claim 1, wherein the sum of components b) to e) in the polystyrene foam composition is lower than 2.5% by weight.

17. The flame retarded and nucleating polystyrene foam composition according to claim 7, wherein the Halogen content in the polystyrene foam composition is lower than 1500 ppm by weight.

18. The flame retarded and nucleating polystyrene foam composition according to claim 7, the Halogen content in the polystyrene foam composition is lower than 900 ppm by weight.

19. The flame retarded and nucleating polystyrene foam composition according to claim 7, wherein the sum of components b) to e) in the polystyrene foam composition is lower than 5% by weight.

20. The flame retarded and nucleating polystyrene foam composition according to claim 7, wherein the sum of components b) to e) in the polystyrene foam composition is lower than 2.5% by weight.
